(19) United States
(12) Patent Application Publication
(10) Pub. No.: US 2024/0417502 A1
(43) Pub. Date: Dec. 19, 2024

(54) MODIFIED AMINOPLASTIC ADHESIVE RESIN, PROCEDURE OF ITS PREPARATION, AND COMPOSITE MATERIALS PREPARED USING THE MODIFIED AMINOPLASTIC ADHESIVE RESIN

(71) Applicant: Lignum Technologies AG, Niederteufen (CH)

(72) Inventors: Manfred DUNKY, Polten (AT); Luis Miguel OLAECHEA, Fribourg (CH); Ingo MAYER, Pieterlen (CH); Reto FREI, Evilard (CH)

(73) Assignee: Lignum Technologies AG, Niederteufen (CH)

(21) Appl. No.: 18/703,114

(22) PCT Filed: Oct. 22, 2021
(86) PCT No.: PCT/EP2021/079346

§ 371 Date: Apr. 19, 2024

(51) Int. Cl. C08G 12/40; B27N 3/00; B27N 3/02; B27N 3/04; B27N 3/06; B27N 3/20; C09J 161/30

(52) U.S. Cl. CPC C08G 12/40; B27N 3/002; B27N 3/02; B27N 3/04; B27N 3/06; B27N 3/203; C09J 161/30

(57) ABSTRACT

A temperature-curable aminoplastic adhesive resin that is a (poly)-condensate of: (i) at least one aminoplast-forming chemical; (ii) 5-hydroxymethylfurfural (5-HMF), its oligomers and/or its isomers; and, (iii) at the least one second (poly-)condensable chemical produced in the presence of an organic sulfonic acid. Composite boards, such as wood-based panels, can be produced using this adhesive resin. The production of the aminoplastic adhesive resins includes the reaction of urea with 5-hydroxymethylfurfural (5-HMF) and glyoxal in the presence of an organic sulfonic acid as a hardener. The adhesive resin can be used in the production of wood-based panels, such as, particleboards, chipboards, fiberboards and products usually called, among others, plywood and/or blockboards, in the presence of an organic sulfonic during curing.

### RELATED APPLICATIONS

This application is a 371 nationalization of international patent application PCT/EP2021/079346, filed on Oct. 22, 2021, the entirety of which is hereby incorporated by reference.

### BACKGROUND

This disclosure relates to a temperature-curable aminoplastic adhesive resin which is a (poly)-condensate of: (i) at least one aminoplast-forming chemical; (ii) 5-hydroxymethylfurfural (5-HMF), its oligomers and/or its isomers; and, (iii) at the least one second (poly-)condensable chemical produced in the presence of an organic sulfonic acid.

Composite boards, such as wood-based panels, just to mention one of many types of composite boards, can be produced using this adhesive resin. In one aspect, the production of the said aminoplastic adhesive resins includes the reaction of urea with 5-hydroxymethylfurfural (5-HMF) and glyoxal in the presence of an organic sulfonic acid as hardener. In a further aspect, said adhesive resin can be used in the production of wood-based panels, such as, but not restricted to: particleboards, chipboards, fiberboards, and products usually called, among others, plywood and/or blockboards in the presence of an organic sulfonic during curing.

### STATE OF THE ART

The reactions between aminoplast-forming chemicals, with urea and melamine as most important, but not exclusive examples, with various types of aldehydes (e.g., formaldehyde as the most important representative), are well known and have been described in chemical literature in a non-manageable number of papers and textbooks, such as by: Dunky (Urea-formaldehyde (UF-) glue resins. Int. J. Adhesion Adhesives 18 (1998) 95-107; Adhesives in the Wood Industry. In: A. Pizzi, K. L. Mittal (Eds.): Handbook of Adhesive Technology, 2^{nd} Ed., Marcel Dekker Inc., 2003, pp. 887-956; Adhesives in the Wood Industry. In: A. Pizzi, K. L. Mittal (Eds.): Handbook of Adhesive Technology, 3^{rd} Ed., 2018, pp. 511-574;Wood Adhesives and Additives. In: Springer Handbook of Wood Science and Technology, A. Teischinger and P. Niemz (Eds.), 2021 (in press); Wood Adhesives Based on Natural Resources: A Critical Review Part IV. Special Topics. Reviews of Adhesion and Adhesives, 9 (2021) 2, 189-268), Dunky and Niemz (Wood-Based Panels and Adhesive Resins: Technology and Influential Parameters (German). Springer, Heidelberg, 2002, 986 p.), and Dunky and Pizzi (Wood Adhesives. In: D. A. Dillard, A. V. Pocius (Eds.): Adhesion Science and Engineering, Volume 2: Issue Surfaces, Chemistry and Applications. Elsevier Science B.V., Amsterdam, The Netherlands. 2003, pp. 1039-1103). Such aminoplastic adhesive resins based on urea and/or melamine, in combination with formaldehyde, are the by far dominating adhesives used in the wood-based panels industry.

Though the former problem of high subsequent formaldehyde emission from such wood-based panels has been eliminated to a large extent, nevertheless, the classification of formaldehyde as cancerogenic substance, on the one hand, and the strong wishes to eliminate synthetic chemicals and replace them by naturally-derived substances, has triggered replacement of formaldehyde in adhesives as they are used for composite boards. Various aldehydes to replace formaldehyde in such resins have been described in literature, such as, among others: Dunky (Wood Adhesives and Additives. In: Springer Handbook of Wood Science and Technology, A. Teischinger and P. Niemz (Eds.), 2021 (in press); Wood Adhesives Based on Natural Resources: A Critical Review Part IV. Special Topics. Reviews of Adhesion and Adhesives, 9, (2021) 2, 189-268) has given an overview on such initiatives.

Among other aldehydes, 5-hydroxymethylfurfural (5-HMF) and glyoxal have been the focus of researchers.

5-HMF can react with urea and melamine. Urea-5-HMF-formaldehyde (UHF) resins with partial replacement of formaldehyde by 5-HMF were prepared by an alkaline-acid method. The formaldehyde emission from particleboards (PB) bonded by UHF was significantly lower compared to urea-formaldehyde (UF) resin. The UHF-bonded boards also showed better mechanical properties compared to boards with UF resins, as well as lower water absorption and thickness swelling (Esmaeili, N., M. J. Zohuriaan-Mehr, S. Mohajeri, K. Kabiri and H. Bouhendi, Hydroxymethyl furfural-modified urea-formaldehyde resin: Synthesis and properties. Eur. J. Wood Prod. 75 (2017) 71-80).

Urea-glyoxal resins with glyoxal replacing formaldehyde are reported in the chemical literature, such as by Deng et al. (Deng, S. D., Li, X. H., Xie, X. G., and Du, G. B. (2013). Reaction mechanism, synthesis and characterization of urea-glyoxal (UG) resin. Chinese Journal of Structural Chemistry, 32 (2013) 12, 17731786; Deng, S.D., G. Du, X. Li, and Pizzi, A. (2014). Performance and reaction mechanism of zero formaldehyde-emission urea-glyoxal (UG) resin. Journal of the Taiwan Institute of Chemical Engineers, 45 (2014) 4, 2029-2038; Deng, S., Du, G., Li, X., and Xie, X. (2014). Performance, reaction mechanism, and characterization of glyoxal-monomethylol urea (G-MMU) resin. Industrial & Engineering Chemistry Research, 53 (2014) 13, 5421-5431; Deng S., Pizzi A., Du G., Lagel M.C., Delmotte L., Abdalla S. (2018). Synthesis, structure characterization and application of melamine-glyoxal adhesive resins, Eur. J. Wood Prod., 76, (2018) 283-296); or Younesi-Kordkheili and Pizzi (Younesi-Kordkheili, H. and Pizzi, A. (2018). A comparison between the influence of nanoclay and isocyanate on urea-glyoxal resins. Int. Wood Prod. J. 9, (2018) 9-14).

Urea-glyoxal resins (also still comprising formaldehyde) have been known for more than half a century, however not as a wood adhesive, but preferably for the textile finishing market for use as wrinkle-recovery, wash-and-wear, and durable press agents (NPCS Board of Consultants & Engineers, The Complete Book on Adhesives, Glues & Resins Technology (with Process & Formulations), second edition, Asia Pacific Business Press Inc., New Delhi, India (2016)).

Resins based on the reaction of urea with 5-HMF and glyoxal in the same procedure have not yet been mentioned in the literature. Glyoxal as a nonvolatile and nontoxic aldehyde was used as a substitution of formaldehyde to prepare melamine-glyoxal (MG) resins as reported by Xi et al. (Xi, X., Liao, J., Pizzi, A., Gerardin, C., Amirou, S., & Delmotte, L. (2019). 5-Hydroxymethyl furfural modified melamine glyoxal resin. The Journal of Adhesion, 1-19). These resins suffered from the lower reactivity of the glyoxal compared with formaldehyde. 5-HMF was therefore used as a modifier to improve the performance of melamine-glyoxal resins by preparing a 5-HMF-modified melamine-glyoxal resin, tested as plywood adhesive resin. The lower reactivity of the glyoxal compared with formaldehyde was improved by addition of 5-HMF. The proportion of 5-HMF in this resin was only small, according to a molar ratio of melamine:glyoxal:5-HMF=1:6:0.3. Based on mass, the proportion of 5-HMF is only 10% based on the sum of aldehydes.

Though the problem of possible inhomogeneity was solved by introducing glyoxal as a third component as described in the international patent application PCT/EP2021/064092, the low curing reactivity remains a general bottleneck with all aminoplastic 5-HMF resins. This is especially true when comparing 5-HMF-based resins with urea-formaldehyde (UF) resin as aminoplastic resin, as this is the type of resin which is the most important type of aminoplastic resins and which is intended to be replaced by 5-HMF-based resins. Generally seen the curing of 5-HMF-based resins aminoplastic resins is similar to standard phenolic resins based on phenol and formaldehyde.

Another problem with all 5-HMF-based liquid aminoplastic resins is the relatively low viscosity even at high solid content (high concentration). A sufficient viscosity at a certain predetermined concentration reflects to a certain extent the size of the resin molecules (degree of condensation). If the degree of condensation is low or too low, means if the viscosity at a certain solid content is low or too low, the resin might strongly penetrate into the porous wood surface. If this penetration is too strong, which usually is called as over-penetration, the residual amount of resin on the wood surface is too low to form a sufficient bond line; the consequences are reduced bond strength and especially low so-called wood failure. Wood failure means that when testing the bonded product, the failure occurs, as usually intended and preferred, in the adjacent wood material of the adherend, and not in the bond line. This means that the bond line as such, formed and determined in its properties by the cohesive bond strength of the cured adhesive resin as such as well as the adhesion bond strength as attraction forces between the wooden adherend and the cohesive adhesive layer, is stronger than the material of the adherend. The common diction then is that the bond strength is sufficient. More details are described extensively in the literature, such as by Dunky (Dunky, M. Adhesives in the Wood Industry. In: A. Pizzi, K. L. Mittal (Eds.): Handbook of Adhesive Technology, 3rd Ed., 2018, pp. 511-574; Dunky, M. (2021). Wood Adhesives and Additives. In: Springer Handbook of Wood Science and Technology, A. Teischinger and P. Niemz (Eds.), in press), as just as two examples.

As opposite, a too high viscosity, caused by very big resin molecules and ending up in inadequate flow and penetration of the adhesive resin into the wooden adherend, also yields low bond strength, but this case is of no relevance in the shortcomings of 5-HMF-based resins as described here. Again, more details can be found in literature, such as by Dunky (for exact references see above).

Therefore, an object of the present disclosure is the improvement of the two shortcoming aspects as described above, which are the insufficient size of the resin molecules risking high or even overpenetration, and the low curing reactivity of the liquid, temperature-curable resins based on 5-HMF, but where these necessary improvements then are valid for all types of resins based on aminoplastic resin forming chemical species, means (i) moieties bearing NH₂- or NH-groups which (ii) are able to react with any type of aldehyde groups R—C(═O) H in the well-known reaction path. A further technical objective of the present disclosure is to provide composite material in which the liquid, temperature-curable resin is used as binder, such as but not restricted to wood based materials, especially OSB panels, particleboards, chipboards, HDF-or MDF-panels or plywood.

5-HMF consists of two functional group attached to the unsaturated heterocyclic ring structure of the basic furan. The one functional group is an aldehyde group; the second functional group is a hydroxyl group. It should be expected that, according to the general chemical experience, both functional groups should react readily if suitable reaction partners are available. Such reaction partners are available indeed, such as phenol in the case of a phenol-5-HMF resin, or urea in case of a urea-5-HMF resin. Assumed formula schemata showing the equally occurring reaction between phenol or urea and both functional groups are described in literature, such as by Zhang et al. (2015, 2016) or Yuan et al. (2014) in the case of the reaction of 5-HMF with phenol (Zhang, Y., Yuan, Z., & Xu, C. Engineering biomass into formaldehyde-free phenolic resin for composite materials. AlChE Journal, 61 (2015) 4, 1275-1283; Zhang, Y., Nanda, M., Tymchyshyn, M., Yuan, Z., & Xu, C. Mechanical, thermal, and curing characteristics of renewable phenol-hydroxymethylfurfural resin for application in biocomposites. Journal of Materials Science, 51 (2016) 2, 732-738; Yuan, Z., Zhang, Y., & Xu, C. C. Synthesis and thermomechanical property study of Novolac phenol-hydroxymethyl furfural (PHMF) resin. RSC Advances, 4 (2014) 60, 31829-31835) or Esmaeili et al. (2017) in the case of the reaction of 5-HMF with urea (N. Esmaeili, M. J. Zohuriaan-Mehr, S. Mohajeri, K. Kabiri and H. Bouhendi, Hydroxymethyl furfural-modified urea-formaldehyde resin: Synthesis and properties. Eur. J. Wood Prod. 75 (2017) 71-80).

Applicant's work shows that preferably the aldehyde group of the 5-HMF had reacted with urea (with or without presence of the glyoxal), but not the hydroxyl group of the 5-HMF. This means a great disadvantage compared to what could have been expected, if both functional groups of the 5-HMF, i.e. the aldehyde group as well as the hydroxyl group, would react with urea in the case of an aminoplastic 5-HMF-based resin. The aldehyde group can react even with two molecules of urea, whereas the hydroxyl group can only link to one urea molecule; but, nevertheless, missing the reaction by the hydroxyl group weakens the system in terms of curing speed and in terms or crosslink density. Curing speed is important to achieve short press times when producing the wood-based panels, which enables high output of a given production line and, hence, lower costs. The crosslink density is a measure for the cohesive bond strength and influences directly the properties of the wood-based panels in terms of strength, moisture and water resistance, and durability.

Accordingly, it is the object of the present disclosure to provide liquid, aminoplastic temperature-curable resins based on 5-HMF which have a higher crosslinking density as well as an increased curing speed. Furthermore, it is the object of the present disclosure to provide a method for preparing aminoplastic temperature-curable resins based on 5-HMF which have a higher crosslinking density as well as an increased curing speed. Additionally, it is the object of the present disclosure to provide composite materials and a method for their preparation using the aforementioned liquid, aminoplastic temperature-curable resins based on 5-HMF.

### BRIEF DESCRIPTION OF THE DRAWINGS

FIG. 1 shows a superposition of DSC curves of a 5-HMF-based resin according to the International patent application PCT/EP2021/064092.

FIG. 2 shows the decrease of the gel time of the investigated 5-HMF resin using pTSA as hardener at higher temperatures.

FIG. 3 shows the increase of the viscosity of a 5-HMF resin +10% pTSA (addition calculated as 100% pTSA based on resin solid content) at various isotherm temperatures (60° C., 70° C., and 80° C.) with time.

FIGS. 4A-B show results of certain mixtures tested by Fourier Transform Infrared Spectroscopy (FT-IR).

FIG. 5 shows a reaction scheme according to the present disclosure.

### DETAILED DESCRIPTION

The present disclosure accordingly discloses a liquid, temperature-curable resin preparable by the (poly)-condensation of
at least one aminoplast-forming chemical, with
5-hydroxymethylfurfural (5-HMF), its oligomers and/or its isomers and
at the least one second (poly-)condensable chemical
in the presence of at least one organic sulfonic acid,
   under reaction conditions under which said at least one aminoplast-forming chemical, 5-hydroxymethylfurfural (5-HMF), its oligomers and/or its isomers, and the at least one second (poly-)condensable chemical (poly-)condensate to the liquid, temperature-curable resin.

All chemicals, if not added in solid form, are given as aqueous solutions with a certain concentration. No organic solvents are required during the preparation of the liquid, temperature-curable resin.

After the chemical reaction between the above mentioned raw materials has been performed, and with this step the liquid, temperature-curable resin has been prepared, a distillation step can follow in order to increase the solid content of the liquid resin and its viscosity according to technologically intended or needed values.

On laboratory scale the distillation step preferably is performed in a suitable distillation equipment, such as a rotovapor evaporation device, as an example under high vacuum of 28-32 mbar at 40° C. The amount of water to be removed is calculated based on the solid content of the liquid, temperature-curable resin before the distillation and the targeted solid content after the upconcentration. On industrial scale this evaporation step will also be performed by such usual procedure under vacuum and at slightly elevated temperature. The detailed conditions for this industrial evaporation step depend on the given equipment.

All solid contents are expressed in percent of the liquid resin and were determined by evaporating the water content of the reaction solution after its preparation under vacuum (7 mbar) at 50° C. until a constant mass has been achieved.

According to another aspect, the present disclosure discloses the curing reaction of the said temperature-curable resin in presence of at least one organic sulfonic acid. As it has been found, surprisingly, the addition of at least one organic sulfonic acid can increase the crosslinking density when forming a three-dimensional chemical network based on the curing reaction of the said temperature-curable resin. Additionally, it turned out that the curing rate at given conditions of temperature and pH increases when acids or acidic chemicals others than organic sulfonic acids are replaced by such organic sulfonic acids, with pTSA as one example, but not the only one for such organic sulfonic acids.

The main objectives of the disclosure, i.e., the improvement of the preparation of a liquid, temperature-curable resin as well as the improved curing behavior of such a liquid, temperature-curable resin, was surprisingly fulfilled by the selection of so-called organic sulfonic acids with the following general chemical formula:

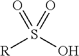

R is the so-called organic rest and can have very different chemical composition.

The residue R can e.g. be selected from the group consisting of linear or branched alkyl groups or unsubstituted or substituted aryl groups. Aryl sulfonic acids are preferred in the present disclosure. In the case of p-toluene sulfonic acid (pTSA)-which is especially preferred-this organic rest is a toluene moiety bonded via its p-position to the sulfonic group. The following chemical formula depicts the chemical structure of pTSA.

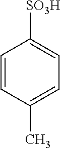

Sulfonic acids in general and pTSA, in order to name the most important representative of this class of chemical substances, are highly acidic and are, therefore, able to adjust the required acidic conditions during the resin preparation step in the reactor and during the curing step in the hot press.

Surprisingly, it was observed that the liquid aminoplastic temperature-curable resins based on 5-HMF exhibit a higher degree of crosslinking, when using an organic sulfonic acid during their preparation, compared to liquid aminoplastic temperature-curable resins based on 5-HMF prepared by using other acids or acidic substances. In addition, the curing reaction under crosslinking, as it is performed in the preparation of cured resins when testing the curing behavior as quality criterion for high performance in the application when producing composite materials, surprisingly was accelerated.

This was a surprising fact, which was not yet mentioned in literature or was not based on general industrial experience. Organic sulfonic acids such as pTSA are partly used in the formulation of lacquer systems or foundry systems, which, however do not use 5-HMF as raw material. Using organic sulfonic acids such as pTSA to adjust the pH to the acidic range enabled also reactions between the hydroxyl groups and urea, hence increasing the number of possible chemical pathways significantly. So far, the shortcoming of the 5-HMF resins using various acids, but others than organic sulfonic acids, as catalysts in the course of the resin production as well as during the curing of the resin-as described below-was the insufficient or even fully missing participation of the OH-groups of the 5-HMF moiety within the 5-HMF resin in the condensation and/or curing step. The term “catalysts” is here used for both processes, resin production and resin curing; for resin curing also the term “hardener” is often used; both terms shall be used in synonym mode here.

This surprising increase in chemical pathways enables more and different reactions ongoing at the same time, with the additional special effects of better formation of the molecular resin network as well as a quicker generation of a dense three-dimensional network upon curing.

With respect to the sum of the at least one aminoplast-forming chemical, 5-hydroxymethylfurfural (5-HMF), its oligomers and/or its isomers and the at the least one second (poly-)condensable chemical it is preferred, that in the production of the said liquid temperature-curable resin the at least one organic sulfonic acid is added in a weight ratio of 1.0 to 3.0 wt.-%, preferably 1.4 to 2.6 wt.-%, especially preferred 1.7 to 2.4 wt.-%. All percentage numbers are related to the organic sulfonic acid calculated as 100% substance based on the sum of the at least one aminoplast-forming chemical, 5-hydroxymethylfurfural (5-HMF), its oligomers and/or its isomers and the at the least one second (poly-)condensable chemical. The amount of the organic sulfonic acid to be dosed is then calculated according to its concentration in water. For example, the organic sulfonic acid is used as an aqueous solution, e.g. with 65% concentration. The amount is therefore given in relation to a (theoretical) 100% sulfonic acid. This means that the amount is independent of the effective concentration of the acid. The effective amount is then calculated from the above data and the respective given concentration.

More details about the use of organic sulfonic acids, such as pTSA, in the resin production and for the curing step during the production of composite materials, such as, but not restricted to, wood-based panels are given in the Examples further down. The addition of the organic sulfonic acid depends on the type of the organic sulfonic acid as well as the type of reaction with the preparation of the temperature-curable resin as such or the application and curing of this said temperature-curable resin in the production of composite materials. The addition especially in the case of the use of pTSA can be in solid form or as aqueous solution.

According to the present disclosure 5-hydroxymethylfurfural, its oligomers and/or its isomers are capable to react with the at least one aminoplast-forming chemical via polycondensation. Furthermore, the at the least one second (poly)-condensable chemical is capable to react with the at least one aminoplast-forming chemical and/or 5-hydroxymethylfurfural (5-HMF), its oligomers and/or its isomers via polycondensation.

The temperature-curable resin according to the present disclosure accordingly is a polycondensate. Preferably the aminoplast forming chemical comprises NH₂ or NH groups and the at least one second (poly-)condensable chemical comprises one or more aldehyde functions.

According to a specific embodiment, the at least one second (poly-)condensable chemical is at least one aldehyde different from 5-hydroxymethylfurfural, its oligomers or its isomers.

Preferably the at least one second (poly-)condensable chemical is glyoxal.

Furthermore, the at least one aminoplast-forming chemical can be selected from the group of consisting of urea, melamine, substituted melamine, substituted urea, acetylenediurea, guanidine, thiourea, thiourea derivatives, diaminoalkane, or diamidoalkane, or mixtures thereof.

According to an advantageous embodiment the (poly)-condensation a molar ratio (a: b: c) of (a) the totality of the at least one aminoplast-forming chemical to (b) the totality of 5-hydroxymethylfurfural (5-HMF), its oligomers and/or its isomers to (c) the totality of the least one second (poly-)condensable chemical is adapted to 1:0.1 to 1.0:0.05 to 0.5, preferably 1:0.2 to 0.4:0.1 to 0.3, particularly preferably 1:0.3 to 0.4:0.15 to 0.25.

The liquid, temperature-curable resin according to the present disclosure may have a solid content of 60-85 mass %, preferably 65-80 mass %. The intended solid content of the resin can be adjusted by a relevant evaporation step.

All solid contents can be determined by evaporating the water content of the reaction solution after its preparation under vacuum (7 mbar) at 50° C. until a constant mass has been achieved. The solid content is then calculated based on the masses before and after the drying step.

According to an additional advantageous aspect, the temperature-curable resin has a viscosity of 150-1,000 mPa*s, preferably 200-600 mPa*s, particularly preferably 200-400 mPa*s. The viscosity here is measured directly at the given liquid resin without any modification, only the temperature of the liquid resin is adjusted to 20° C. The measurement is done in the usual way as known to each expert by a rotational viscosimeter (such as Brookfield viscosimeter), also described in EN ISO 3219:1994 Annex B.

According to the present disclosure and equally as already stated in the International patent application PCT/EP2021/064092, 5-hydroxymethylfurfural (5-HMF) and its oligomers and/or its isomers are capable to react with the at least one aminoplast-forming chemical via polycondensation. Furthermore, the at the least one second (poly-)condensable chemical is capable to react with the at least one aminoplast-forming chemical and/or 5-hydroxymethylfurfural (5-HMF), its oligomers and/or its isomers via polycondensation.

The liquid, temperature-curable resin according to the present disclosure accordingly is a polycondensate. Preferably the aminoplast forming chemical comprises NH₂- or NH-groups and the at least one second (poly-)condensable chemical comprises one or more aldehyde functions.

As described in the International patent application PCT/EP2021/064092, it was experienced that the (poly-)condensation of at least one aminoplast-forming chemical, 5-hydroxymethylfurfural (5-HMF), its oligomers and/or its isomers, and at the least one second (poly-)condensable chemical can overcome the short-comings as they are described above in details.

Other shortcomings, such as relatively low viscosities (at a certain solid content of the aqueous resin) and the low curing reactivity, however, remained and where not yet solved by the invented procedure as described in the International patent application PCT/EP2021/064092.

According to the second aspect, the present disclosure relates to a method for the production of a liquid, temperature-curable resin by (poly)-condensation of
at least one aminoplast-forming chemical with
5-hydroxymethylfurfural (5-HMF), its oligomers and/or its isomers and
at the least one second (poly-)condensable chemical
in the presence of at least one organic sulfonic acid,
   under reaction conditions under which said at least one aminoplast-forming chemical, 5-hydroxymethylfurfural (5-HMF), its oligomers and/or its isomers and the at least one second (poly-)condensable chemical (poly) condensate to the temperature-curable resin.

The specifics and preferred embodiments for the organic sulfonic acids as far as quality or quantity of their addition are given above.

According to the method of the present disclosure the reactants (poly)-condensate to the temperature-curable resin under the special premise that for the adjustment of the acidic pH during the resin production process an organic sulfonic acid, such as, but not restricted to, p-toluene sulfonic acid (pTSA) is used instead of other acids or acidic substances, as such chemicals are used generally. Another premise is that for curing the resin again an organic sulfonic acid, such as, but not restricted to, pTSA is added to the resin in order to adjust the low pH. The organic sulfonic acid, such as, but not restricted to, pTSA is preferably used in order to achieve the surprisingly found special effect as described more in detail below.

A specific embodiment of the inventive method foresees that the (poly)-condensation is performed at temperatures in the range from 10 to 90° C., preferably in the range from 20 to 60° C., particularly preferably in the range from 20 to 50° C.

The (poly-)condensation can be carried out in a solution until the solution has reached a predefined viscosity or the reaction is complete.

A third aspect of the present disclosure relates to a method for the production of composite materials, comprising the following steps:
provision of a liquid, temperature-curable resin according to the present disclosure,
bringing into contact the temperature-curable resin with lignocellulose containing or non-lignocellulose containing material or a mixture thereof,
preparation of a curable mass, and
curing of the curable mass under formation of the composite material, said curing being carried out by means of elevated temperature and pressure (e.g. vis-à-vis standard conditions as defined in ISO 2533:1975, i.e. 15° C. and 101.325 kPa),
   wherein the curing of the resin in the curable mass is induced by decreasing the pH of the resin by adding an organic sulfonic acid as acidic hardener.

The specific premise of this aspect of the disclosure is that for the adjustment of the acidic pH during the resin production process an organic sulfonic acid, such as, but not restricted to, p-toluene sulfonic acid (pTSA) is used instead of other acids or acidic substances, as such chemicals are used generally. Another premise is that for curing the resin again an organic sulfonic acid, such as, but not restricted to, pTSA is added to the resin in order to adjust the low pH. The organic sulfonic acid, such as, but not restricted to, pTSA is preferably used in order to achieve the surprisingly found special effect of an increased crosslinking density as well as a higher curing rate of the resin, as described more in detail below.

For the curing of the said temperature-curable resin during the production of the composite materials the organic sulfonic acid preferably is added in a ratio of 5 to 20 wt.-%, preferably 7 to 15 wt.-%, especially preferred 8 to 12 wt.-%. All percentage numbers are related to the organic sulfonic acid calculated as 100% substance based on the solid mass of the liquid, temperature-curable resin. In order to calculate the amount of the aqueous solution of the organic sulfonic acid which has to be added, the relevant percentage numbers as stated above in this paragraph are e.g. recalculated using the concentration of the organic sulfonic acid as well as the solid content of the liquid resin.

Liquid resins, as they are prepared and used in the course of this patent and the relevant patent claims consists of two main components, which are (i) the condensated molecules based on the raw materials used in the preparation process, and (ii) water. The possible but small residual amounts of monomers (raw materials) are, for the sake of simplicity, taken as included in the amount of condensated molecules. This water comes from the solutions of some the various raw materials, if they are not added in solid form, and is partly additionally added if a certain concentration of the reaction mix shall be adjusted.

The solid content of the liquid resin, which resin by definition for this disclosure is an aqueous liquid resin, is determined by removing (by distillation) of the water content which is given in the liquid resin after its preparation, which step can also be called drying step. The remaining part after distillation of all water and achieving a constant mass situation in the distillation step is then expressed as solid content of the resin defined by “remaining mass based on the liquid resin before starting the drying step”.

As it is known to the person skilled in the art in the field of condensation resins, the determined solid content of the resin depends on the conditions during this drying step. For the disclosure here, the drying conditions when determining the solid content were defined as drying under high vacuum (7 mbar) at 50° C. until mass equilibrium has been achieved during the drying step. All numbers indicating solid contents of liquid resins as described in the course of this disclosure are determined in this way.

A specific embodiment of this method is characterized in that the lignocellulose-containing materials or the non-lignocellulose containing materials are selected from the group consisting of wood chips, wood fibers, plant fibers, wood flakes, wood strands, wood particles, wood stripes, mixtures of various lignocellulosic materials, inorganic fibres, inorganic fibre mats, and mixtures of these.

Moreover, the lignocellulose-containing or the non-lignocelluose containing material is mixed with an amount of 2% by weight to 20% by weight of the solid content, preferably with an amount of 5% by weight to 15% by weight of the solid content, of the temperature-curable resin, based on the weight of the dry lignocellulose-containing or non-lignocellulose containing material.

Advantageously, the curing of the resin during production of a composite material, such as, but not restricted to, particleboard, is carried out in a press at temperatures of 160 to 250° C. (i.e. temperature of the press platen or press belts). This pressing step of the curable mass, which consists, among other ingredients, mainly of the wooden material, such as particles or fibres, and the adhesive system, can take place in a flat press, continuous press, or molding press, as these technologies as such are well known and are described in technical literature, such as by Dunky and Niemz (Dunky, M. and Niemz, P. (2002). Wood-Based Panels and Adhesive Resins: Technology and Influential Parameters (German). Springer, Heidelberg, 986 p.). The necessary mechanical pressure when closing the press and densifying the curable mass (in technical language mostly called “mat”, such as “particle mat” in case of particleboards or “fibre mat” in case of fibreboards) depends, among other parameters, mainly on the density of the produced composite material. Depending on the type of the press the pressure can be constant over the whole press process or, as usually given, will follow a certain pressure program depending either on time or on the evolution of the thickness of the compressed curable mass. The aforementioned adhesive system comprises the liquid temperature-curable resin, the organic sulfonic acid, such as pTSA, as initiator for the acidic curing reaction (“hardener”) as well as other possible ingredients as they might be added to an adhesive mix such as water, release agents, antifoaming agents, colours, and others, without restriction to these explicitly mentioned ingredients. The various components of the adhesive mix might be premixed before they are applied as adhesive mix onto the wood material, or they might be sprayed separately, as this is also open and well-known practice.

Finally, the present disclosure relates to a composite material, obtained by a method according to the present disclosure as described in the foregoing, preferably composite boards based on wood or inorganic materials, especially in form of wooden particleboards, fiberboards, OSB panels, HDF-or MDF panels, plywood and/or blockboards, which can be used among other applications as e.g. flooring, wall or ceiling panels.

The present disclosure will be described in detail in the following Examples without limiting the disclosure to the specific details given.

The preparation of the composite materials preferably follows the usual and well-known procedures, as they are described in literature, such as in the case of wood-based panels by Dunky and Niemz (Dunky, M. and Niemz, P. (2002). Wood-Based Panels and Adhesive Resins: Technology and Influential Parameters (German). Springer, Heidelberg, 986 p.). The procedure of the production of composite materials includes (i) the preparation and provision of the cellulosic or inorganic materials such as particles, strands, or fibers, to give only few examples of many examples suitable within the procedure of the production of composite materials, (ii) the preparation and provision of the suitable and necessary adhesive and adhesive mix, including not only the adhesive, but also other components such as hardeners or crosslinkers, (iii) the provision of other additives or components, such as paraffin in various form as hydrophobic agent, (iv) mixing according the well-known technologies of the various components as mentioned under (i) to (iii), (v) preparation of a mass with certain structures and sizes under various sequences of one or several layers, (vi) pressing of this mass under impact of temperature and various pressures for a certain time, whereby the temperature can vary in a broad range and where the pressures are selected accordingly in order to achieve the formation of the intended composite materials, and finally (vii) cooling of the composite materials. The relevant conditions and details in the various steps (i) to (vi) depend on many parameters, such as the types of the wooden or inorganic raw materials, the types of a chemical components added, and the types, size, and shape of the composite materials as they shall be produced, to just mention here the most important parameters. Each expert on the field of the production of composite materials knows a large number of influential parameters to be considered and followed in order to achieve the intended results.

The following examples shall only act as exemplary and more detailed description of the disclosure without restriction the scope of the disclosure.

### EXAMPLE 1

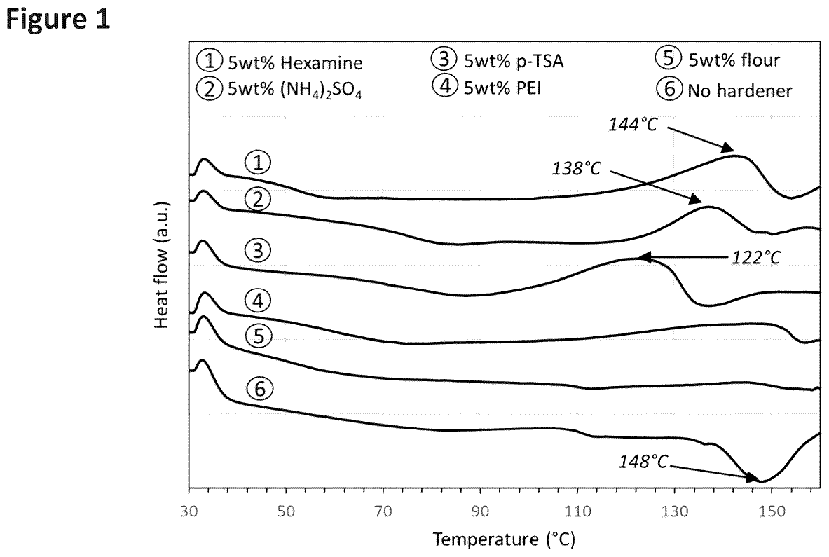

In a first attempt to improve the curing behavior of a 5-HMF-based resin according to the international patent application PCT/EP2021/064092, different hardeners and crosslinkers were tested by means of Differential Scanning Calorimetry (DSC) after mixing them with such a 5-HMF resin. Crosslinkers are chemical substances, which can chemically react with the resin under increase of the molecule size due to linking various molecules together by chemical bonds. For this series of experiments, (i) ammonium sulfate ((NH₄)₂SO₄) as typical hardener for aminoplastic resins, (ii) hexamethylenetetramine (hexamine, (CH₂)₆N₄), as often used for the crosslinking of tannins, and (iii) polyethylene imine (PEI), all in amounts of 5 wt.-% relative to the solid content of the resin), and (iv) p-toluene sulfonic acid (pTSA, in amount of 10 wt.-% relative to the solid content of the resin) were added to the resin; the DSC-temperature profile was monitored from 30 to 160° C. at an temperature increment of 10° C./min. The thermographs, as shown in FIG. 1, indicate that without hardener or crosslinker (line (\hat{6})) no exotherm peak was observed. Usually the curing reaction is exotherm, showing a relevant exotherm peak. Instead, an endotherm peak at 148° C. was recorded. When wheat flour (line (\hat{5})), but still no hardener or crosslinker, or PEI as crosslinker (line (\hat{4})) were tested, the endotherm peak disappeared and a slight but very broad exotherm peak was observed; this indicates that only some weak curing or crosslinking reactions have taken place. When ammonium sulfate (line (\hat{2})) or hexamethylenetetramine (line (\hat{1})) were added, finally an exotherm peak appeared at 138° C. and 144° C., respectively. The most interesting result surprisingly was obtained when pTSA was added to the 5-HMF resin for the DSC investigations (line (\hat{3})). In this case, a significant shift of the exothermic peak to a lower temperature was detected; the exotherm signal spans from 90-100° C. as starting point to 136° C. as endpoint, with a maximum at 122° C. These DSC results are the surprising evidence in this series of experiments; though ammonium sulfate and hexamethylenetetramine showed a certain exothern curing beha-vior, only pTSA yielded in a significant and acceptable improvement.

FIG. 1 shows a superposition of the DSC curves of a 5-HMF-based resin according to the International patent application PCT/EP2021/064092 with the composition expressed as molar ratios of the components 5-HMF:U:G=1:3:0.45; resin (no addition of acids, hardeners, or crosslinkers (line (\hat{6})); addition of 5 wt.-% (based on liquid resin) of wheat flour (line (\hat{5})); addition of 5 wt.-% of PEI (based on liquid resin) (line (\hat{4})); addition of 10 wt % of pTSA (based on solid resin) (line (\hat{3})) addition of 5 wt.-% (based on solid resin) of ammonium sulfate ((NH₄)₂SO₄) (line (\hat{2})); and addition of 5 wt.-% (based on solid resin) of hexamethylenetetramine (line (\hat{1})).

### EXAMPLE 2

In another experiment to characterize the improvement of the curing behavior of a 5-HMF resin by the addition of an organic sulfonic acid, gel times at 100° C. were determined. For these tests, p-toluenesulfonic acid (pTSA) as a hardener and poly (ethyleneimine) (PEI) as crosslinker in different amounts and at different pHs were used. In the case of pTSA the relevant pH was adjusted directly by the pTSA; in case of PEI the relevant pHs were adjusted by either by NaOH for the high pH and by sulphuric acid for the low pH. The gel time measurements were performed using the GELNORM® device at 100° C.

The GELNORM® test device GT-S Slim Line Geltimer with integrated control and time measuring equipment was used to measure the gelation times at 100, 110, 120 and 130° C., resp. A certain amount of the liquid samples of the various resin mixes (including resin and acid/hardener/crosslinker) were poured into a test tube; the test tube was inserted into the test device, and the resin mix was stirred in the device under the various temperatures until gelation occurred. The results are summarized in Table 1.

As it can be seen from Table 1, gelation was only obtained when 10 wt.-% of pTSA (percentage number expressed as solid pTSA based on solid content of the resin) was added, yielding a pH=2. The measured gelation times are in the range of 65 to 70 minutes at 100° C. (i.e. Exp #1, several repetitions of the tests). The 5-HMF resin used in the experiments as described in Table 1 was prepared using the base recipe as described in the international patent application PCT/EP2021/064092, with the composition expressed as molar ratios of the components 5-HMF:U:G=1:3:0.45.

On the other hand, the use of polyethyleneimine (PEI) as crosslinker, even at very different pH of pH=11 (Exp. #2) and pH=2 (Exp. #3), gave no gelation. This suggests, that the gelation, as this had been found surprisingly, is really enhanced/provoked by the presence of the sulfonic acids in the reaction, such as the pTSA, and not simply by the pH as such. Rheometric tests with hydrochloric acid (HCl) and pTSA confirm that a relevant increase in viscosity at short reaction times as consequence of a curing reaction only occurred when pTSA was used.

TABLE 1
Gelation times at 100° C. of various 5-HMF resin mixes using
pTSA or other components to adjust the pH or as hardener or crosslinker

| | | | Time |
|---|---|---|---|
| Exp. # | Added hardener or crosslinker | pH | (min) |
| 1 | acidified with 10 wt.-% of pTSA (expressed | 2.0 | 65 to 70 |
| | as solid pTSA based on the solid content of | | |
| | the resin); results of several repetitions | | |
| 2 | 10% PEI (based on liquid resin) + NaOH to | 11.0 | >120 |
| | adjust the pH | | |
| 3 | 10% PEI (based on liquid resin) + sulphuric | 2.0 | >120 |
| | acid to adjust the pH | | |
| 4 | 3% PEI (based on liquid resin) added to the | 9.6 | >120 |
| | 5-HMF resin + NaOH to adjust the pH | | |
| 5 | 3% PEI (based on liquid resin) + NaOH to | 7.0 | >120 |
| | adjust the pH | | |

### EXAMPLE 3

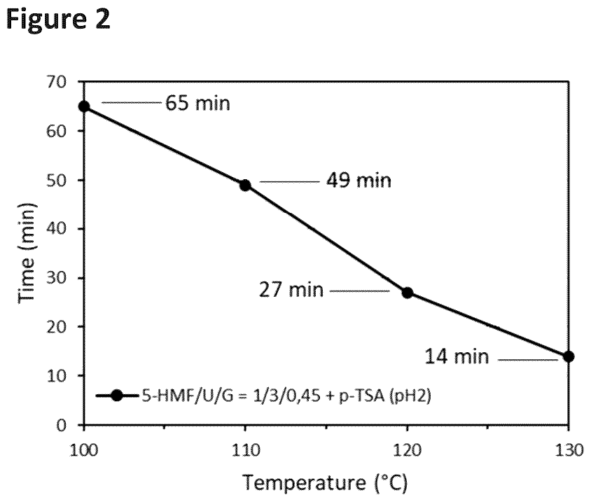

Gelation time experiments were also carried out at higher temperatures (110, 120, and 130° C.), in comparison with Example 1, where the gel time had been measured at 100° C. The gel time measurements at the indicated higher temperatures were performed with the same resin mix and the same adjusted pH as for the Experiment #1, as it is described in Example 1. The results, including the gel time at 100° C. from Example 1 for the Experiment #1 (here taken 65 minutes as one of the results during the replications of the tests at 100° C.), are depicted in FIG. 2. Increasing the temperature decreases, as expected, the gelation time; this decrease shows approximate linear behavior. The gelation of the resin induced by pTSA can be attributed to an increase in molecule sizes due to the condensation of the hydroxyl groups of the 5-HMF moieties present in the oligomers, as this fact was surprisingly detected when using pTSA as hardener. The decrease in gel time follows the usual increase in reactivity by higher temperatures, as this can also be expressed by the so-called Arrhenius equation, which describes the connection between the reaction rate of a reaction and the temperature of the reacting system.

The resin used in these measurements corresponds to 5-HMF resins as described in the international patent application PCT/EP2021/064092. The specific composition of the resin used for the tests described here was, based on the molar ratios of the three components 5-HMF:urea:glyoxal=1.0:3.0:0.45. To adjust the low pH=2.0, again 10 wt.-% of pTSA (calculated as solid pTSA based on solid resin) was used.

FIG. 2 shows the decrease of the gel time of the investigated 5-HMF resin using pTSA as hardener at higher temperatures.

As it had been surprisingly detected, organic sulfonic acids, such as, but not restricted to, pTSA, can effectively activate the reaction of the hydroxyl groups in 5-HMF in the reaction with urea, leading to an increase in degree of condensation and, hence, in molecule sizes and viscosity. This additional reaction path enables formation of a tighter network as well as a shorter gel time as measure for reaching the cured, three-dimensionally crosslinked state.

### EXAMPLE 4

In the course of Example 3 also tests on a rheometer were performed at isothermal conditions at 60° C., 70° C., and 80° C., resp.

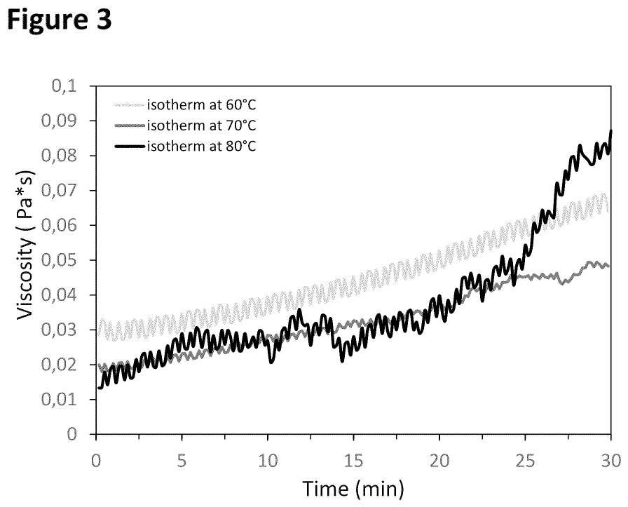

The used resin was again a 5-HMF resin based on the recipes as given in the international patent application PCT/EP2021/064092. The specific composition of the resin used in these investigations was based on the molar ratios of the three components 5-HMF:urea:glyoxal=1.0:3.0:0.45. The adjustment of the pH to 3 was performed using pTSA. The amount of pTSA added in order to induce the acidic curing mechanism was 10 wt.-% of pTSA (calculated as 100% substance) based on solid content of the resin; the resin solid content was determined with 80%). The viscosities at the various temperatures were monitored and are shown in FIG. 3.

The viscosity was measured using a Discovery HR-2 rheometer from TA instruments using a UHP (upper heating plate) geometry with 25 mm disposable plates. Viscosities were measured in the range of shear rates between 10 and 100 s⁻¹. For measures were heat is applied, the part of the sample exposed to the air was coated with silicon oil to prevent water evaporation.

When the isotherm was conducted at 60° C. (light grey line), a continuous increase of the viscosity starting at 30 mPa*s and reaching 70 mPats after 30 minutes is given. When the isotherm treatment was conducted at 70° C. (dark grey line), a similar increase of the viscosity as for 60° C. was obtained; the viscosity level as such is slightly lower due to the higher temperature during the viscosity measurement as such. Finally, for the isotherm treatment at 80° C. (black line), a significant increase in viscosity was observed (though the measurement of the viscosity was performed at 80° C., taking into consideration that a viscosity is always lower when measured at a higher temperature), making evident the strong reaction ongoing at this higher temperature. These experiments show that the use of pTSA can increase the molecule sizes and the viscosity, depending on the temperature, as this strong reaction involving the OH groups of the 5-HMF moiety has been surprisingly found. This behavior is an important basis in order to tailor made the necessary molecule sizes for the various application modes of the 5-HMF resin.

FIG. 3 shows the increase of the viscosity of a 5-HMF resin+10% pTSA (addition calculated as 100% pTSA based on resin solid content) at various isotherm temperatures (60° C., 70° C., and 80° C.) with time. Note the steep increase in viscosity starting at approx. 20 minutes for the experiment at 80° C. The viscosities have been determined at the indicated temperatures and are expressed as [Pa*s].

### EXAMPLE 5

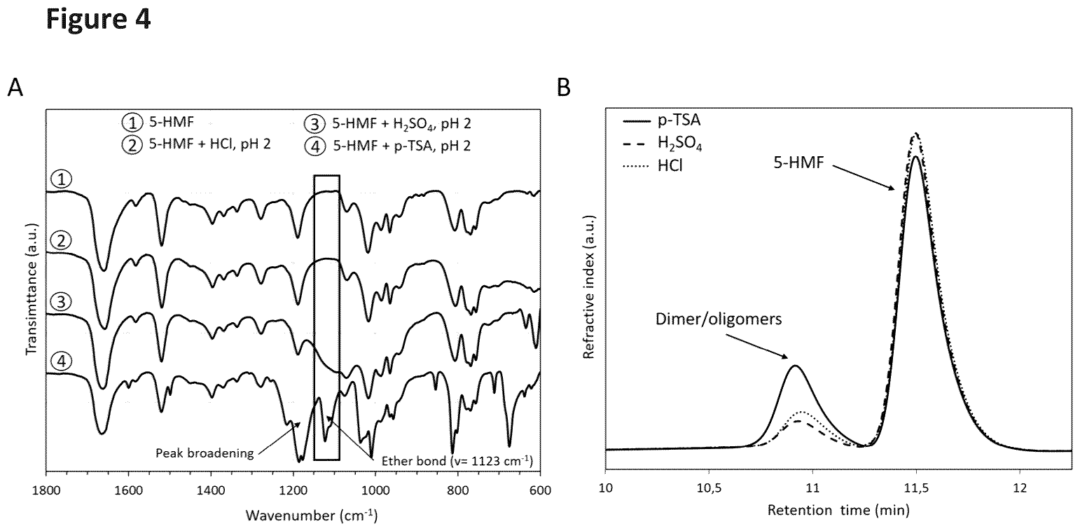

In order to induce the condensation of the hydroxyl group of the 5-HMF and to prove that this reaction has taken place, a 50 wt.-% 5-HMF solution was reacted at 95° C. for 1 hour with (i) HCl, (ii) H₂SO₄, or (iii) pTSA; the acidity of the mixture was adjusted in all cases to pH=2.0. Each mixture was then tested by Fourier Transform Infrared Spectroscopy (FT-IR). The results are shown in FIG. 4. FT-IR is a spectroscopy method that records the interaction of infrared radiation/light with a sample via absorption, emission, or reflection. When the frequency of the radiation matches the vibrational frequency of a bond, the radiation is absorbed increasing the amplitude of such vibration. As each type of bond vibrates at a characteristic wavenumber (wavenumber=1/wavelength of irradiation in cm), this tool is very useful to identify functional groups and chemical structures in a molecule. More details can be found in the literature, such as P. Griffiths and J. A. de Hasseth, Fourier Transform Infrared Spectrometry (2^{nd} ed.), Wiley-Blackwell. ISBN 978-0-471-19404-0 (2007).

As it can be seen from FIG. 4A, the reaction using hydrochloric acid HCl as an acid/hardener (spectrum (\textcircled{2})) does not show different FT-IR bands and characteristics compared to the FT-IR scan of the pure 5-HMF (spectrum (\textcircled{1}). Using sulphuric acid (H₂SO₄, spectrum (\textcircled{3})) a slight change in the spectrum in the region between 1150 and 1075 cm⁻¹ (see marked square in FIG. 4A) can be observed; however, only when using pTSA as acid in order to adjust a low pH (spectrum (\textcircled{4})), a clear and strong vibration peak appears at 1123 cm⁻¹, which most obviously reflects the formation of ether bridges. In FTIR studies of humins formed from 5-HMF this band is attributed to the formation of ether bonds (Tsilomelekis et al., Green Chem. 18 (2016) 1983-1993; Sumerskii et al., Russ. J.Appl. Chem. 83 (2010) 320-327). Also a certain broadening of the peaks in the region of 1250 to 1150 cm⁻¹ was reported by these authors, which is also visible in the spectrum of 5-HMF after reaction with pTSA. All these reactions were performed at pH=2.0, independently of the acid used. Based on the findings it can be concluded, that this possible formation of ether bonds is related to the presence of pTSA and not to the pH of the mixture.

In a further part of this Example 5 the mixtures were then measured by so-called gel permeation chromatography (GPC) to investigate if a dimer or oligomers of 5-HMF have been formed (FIG. 4B).

The GPC is a chromatographic method, which distinguishes an oligomer or a polymer according to the hydrodynamic volume of the individual molecules. On a coarse view, assuming similar degree of branching or crosslinking, this hydrodynamic volume is proportional to the molar mass.

The following test conditions in the GPC measurements have been used: Samples were measured with an Agilent Technologies Series 1100 using a Plgel MIXED-E, 300×10 mm, 3 μm column also from Agilent at 30° C., and using DMF as mobile phase. Measures were performed injecting 10 μl of a 5 mg/ml solution (DMF as solvent) of the samples to be tested and measured with a flow rate of 0.8 mL/min in a 12 minutes run. Detection was performed using an UV detector.

The various GPC curves in FIG. 4B show a certain small formation of dimers/oligomers also for HCl and sulphuric acid; however only for pTSA a significant observation of dimers was evident (FIG. 4B).

FIG. 4: (A): FTIR spectra of: 5-HMF (95%) (spectrum (\textcircled{1})); 50 wt.-% 5-HMF solution after reaction at pH=2 for 1 h at 95° C. using HCl (spectrum (\textcircled{2})); 50 wt.-% 5-HMF solution after reaction at pH=2 for 1 h at 95° C. using H₂SO₄ (spectrum (3), and 50 wt.-% 5-HMF solution after reaction at pH=2 for 1 h at 95° C. using pTSA (spectrum (\textcircled{4})). (B): Superposition of the GPC curves of the 50 wt.-% 5-HMF solution after reaction at pH=2 for 1 h at 95° C. using either HCl ( . . . ), H₂SO₄ ( - - - ), or pTSA (black full line).

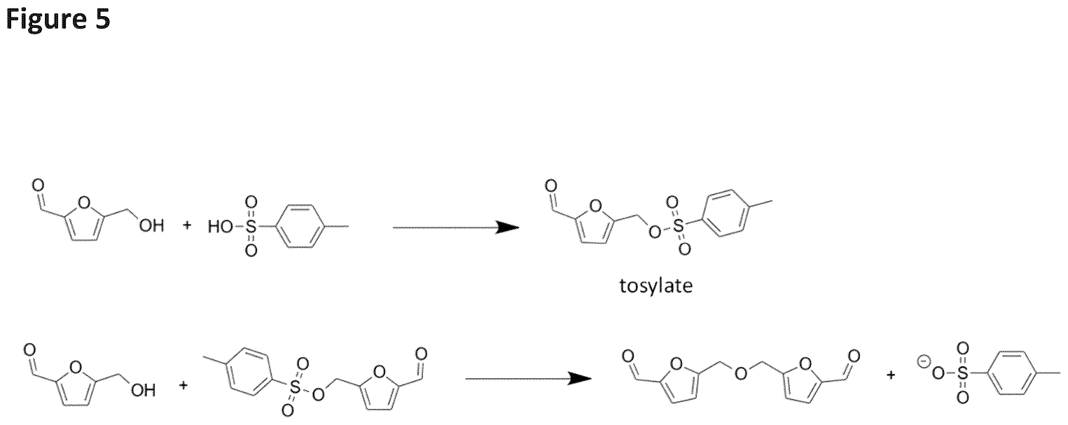

As originally found surprisingly by empirically driven experiments, it can be assumed, based on the findings of the Examples 1-4, that reactions as shown in the following chemical schematic (FIG. 5) take place, including the hydroxyl group of the 5-HMF in the reaction in presence of pTSA, finally leading to ether bridges between two 5-HMF molecules under reaction of their hydroxyl groups. More precisely, 5-HMF condensates with pTSA to form the tosylate which is then more reactive towards an hydroxyl group of an unreacted 5-HMF. Additionally, the tosylate should also be more reactive towards other nucleophiles such as amine or thiols.

The reaction scheme as depicted in FIG. 5 shows—without being bound to theory—the possible formation of ether bonds between the hydroxyl groups of two 5-HMF molecules when pTSA is used.

1. A temperature-curable resin preparable by the (poly)-condensation of:
at least one aminoplast-forming chemical, with
5-hydroxymethylfurfural (5-HMF), its oligomers and/or its isomers, and at the least one second (poly-)condensable chemical,
in the presence of at least one organic sulfonic acid,
under reaction conditions under which said at least one aminoplast-forming chemical, 5-hydroxymethylfurfural (5-HMF), its oligomers and/or its isomers and the at least one second (poly-)condensable chemical (poly-)condensate to the temperature-curable resin.

2. The temperature-curable resin according to claim 1, wherein the organic sulfonic acid is p-toluene sulfonic acid (pTSA).

3. The temperature-curable resin according to claim 1, wherein with respect to the sum of the at least one aminoplast-forming chemical, 5-hydroxymethylfurfural (5-HMF), its oligomers and/or its isomers and the at the least one second (poly-)condensable chemical the at least one organic sulfonic acid is added in a weight ratio of 1.0 to 3.0 wt.-%.

4. The temperature-curable resin according to claim 1, wherein the at least one second (poly-)condensable chemical is at least one aldehyde different from 5-hydroxymethylfurfural, its oligomers or its isomers.

5. The temperature-curable resin according to claim 1, wherein the at least one second (poly-)condensable chemical is glyoxal.

6. The temperature-curable resin according to claim 1, wherein the at least one aminoplast-forming chemical is selected from the group of consisting of urea, melamine, substituted melamine, substituted urea, acetylenediurea, guanidine, thiourea, thiourea derivatives, diaminoalkane, or diamidoalkane, or mixtures thereof.

7. The temperature-curable resin according to claim 1, characterized in that wherein in the (poly-)condensation a molar ratio (a:b:c) of (a) the totality of the at least one aminoplast-forming chemical to (b) the totality of 5-hydroxymethylfurfural (5-HMF), its oligomers and/or its isomers to (c) the totality of the least one second (poly-)condensable chemical is adapted to 1.0:0.1 to 1.0:0.05 to 0.5.

8. The temperature-curable resin according to claim 1, having a solid content of 60-85 mass %, all solid contents determined by evaporating the water content of the reaction solution after its preparation under vacuum until a constant mass has been achieved.

9. The temperature-curable resin according to claim 1, having a viscosity of 150-1,000 mPa*s, all viscosities measured using a rotational viscosimeter at 20° C. according to ISO 3219:1994.

10. A method for the production of a temperature-curable resin, the method comprising (poly-)condensation of:
at least one aminoplast-forming chemical, with
5-hydroxymethylfurfural (5-HMF), its oligomers and/or its isomers, and
at the least one second (poly-)condensable chemical,
in the presence of at least one organic sulfonic acid,
under reaction conditions under which said at least one aminoplast-forming chemical, 5-hydroxymethylfurfural (5-HMF), its oligomers and/or its isomers, and the at least one second (poly-)condensable chemical (poly-)condensate to the temperature-curable resin.

11. The method according to claim 10, that wherein with respect to the sum of the at least one aminoplast-forming chemical, 5-hydroxymethylfurfural (5-HMF), its oligomers and/or its isomers, and the at the least one second (poly-)condensable chemical the at least one organic sulfonic acid is added in a weight ratio of 1.0 to 3.0 wt.-%.

12. The method according to claim 10, wherein the (poly-)condensation is performed at temperatures in the range from 10 to 90° C.

13. The method according to claim 10, wherein the (poly-)condensation is carried out in a solution until the solution has reached a predetermined viscosity or the reaction is complete, wherein the pH is adjusted by the addition of the organic sulfonic acid.

14. A method for the production of composite materials, comprising:
providing of a temperature-curable resin according to claim 1,
bringing into contact the temperature-curable resin with lignocellulose containing or non-lignocellulose containing material or a mixture thereof,
preparing a curable mass, and
curing of the curable mass under formation of the composite material, said curing being carried out by means of elevated temperature and pressure,
wherein the curing of the curable mass is induced by decreasing the pH of the solution range by adding an organic sulfonic acid as acidic hardener to the curable mass.

15. The method according to claim 14, wherein the organic sulfonic acid with respect to the solid content of the resin the organic sulfonic acid is added in a ratio of 5 to 20 wt-%.

16. The method according to claim 14, wherein the lignocellulose-containing materials or the non-lignocellulose containing materials is selected from the group consisting of wood chips, wood fibers, plant fibers, wood flakes, wood strands, wood particles, wood stripes, mixtures of various lignocellulosic materials, inorganic fibres, inorganic fibre mats, and mixtures of these.

17. The method according to claim 14, wherein the lignocellulose-containing or the non-lignocelluose containing material is mixed with an amount of 2% by weight to 20% by weight, of the temperature-curable resin, based on the weight of the dry lignocellulose-containing or non-lignocellulose containing material.

18. The method according to claim 14, wherein the step of preparing of a curable mass is carried out in a flat press, continuous press or molding press.

19. The method according to claim 14, wherein the curing of the resin is carried out in a press at a press temperature of 160 to 250° C.

20. A composite material, obtained by a method according to claim 14, made of wood or inorganic materials as main components, in a form of wooden particleboards, fiberboards, OSB panels, HDF-or MDF panels, plywood and/or blockboards, for applications such flooring-, wall- or ceiling panels.
